(19) United States
(12) Patent Application Publication
(10) Pub. No.: US 2008/0052163 A1
(43) Pub. Date: Feb. 28, 2008

(54) SYSTEM AND METHOD FOR MANAGING A PURCHASE OF A PRODUCT FROM A VENDOR

(76) Inventor: Tze Chuah Koh, Singapore (SG)

Correspondence Address: FISH & RICHARDSON PC, P.O. BOX 1022, MINNEAPOLIS, MN, 55440-1022, US

(21) Appl. No.: 11/832,140

(22) Filed: Aug. 1, 2007

(30) Foreign Application Priority Data
Aug. 1, 2006 (SG) 200605173-4

(51) Int. Cl. G06Q 30/00

(52) U.S. Cl. 705/14; 705/26; 705/39

(57) ABSTRACT

A method of managing a purchase of a product from a vendor includes receiving a plurality of purchase requests from a plurality of buyers, generating a collective purchase order based on the plurality of received purchase requests, where the collective purchase order includes information indicative of each product sought for purchase by the plurality of buyers, and information indicative of a delivery location for the products to be purchased, submitting the collective purchase order to the vendor to effect purchase of the products, and allocating portions of the delivery cost amongst the plurality of buyers in accordance with a predetermined allocation criteria.

### CLAIM TO PRIORITY

This patent application claims priority to Singapore Patent Application No. 200605173-4, which was filed on Aug. 1, 2006 (inventor: Tze Chuah Koh). The contents of Singapore Patent Application No. 200605173-4 are hereby incorporated by reference into this patent application as if set forth herein in full.

### TECHNICAL FIELD

This patent application describes a system and method for managing a purchase of a product from a vendor, and in particular, but not limited to, managing a purchase of a product from an Internet accessible vendor.

### BACKGROUND

The Internet is widely used by consumers as a convenient medium by which to purchase all manner of products advertised via retail web sites. For instance, well known Internet vendors such as Amazon.com provide consumers with access to a searchable catalog of products for sale, and, an online interface through which products can be purchased by buyers at the click of a button.

For a consumer, the cost incurred in acquiring a product from an online vendor typically includes at least a cost of purchasing the product itself (i.e. a “product price”), and, a cost for delivering the purchased product to the consumer (i.e. a “delivery cost”).

Accordingly, various approaches have been adopted by consumers in seeking to reduce the overall cost incurred in acquiring a product online. For instance, where a number of different consumers have been interested in purchasing the same product from a common online vendor, the consumers may agree to band together and submit a “collective purchase offer” to the vendor so as to collectively increase their purchase power over the online vendor. Consequently, the online vendor may be encouraged to reduce the overall cost of acquiring the product for each consumer by reducing the product price component for acquiring the product. Generally, the purchase price of the product tends to be increasingly lowered by the vendor as more buyers band together to purchase the product from the vendor.

Unfortunately, prior art approaches tend to suffer from certain disadvantages. Firstly, their effectiveness in being able to lower the overall cost of acquiring a product for each participating consumer is dependent upon all of the consumers agreeing to purchase the same specific product. Thus, consumers seeking to acquire relatively less popular products from the vendor generally miss out on the cost-saving benefits obtained from participating in group purchases.

Secondly, prior art collective purchase schemes have tended to be coordinated via online forum-based environments which tend to be disorganized, unstructured, and consequently, are ill-suited for prospective buyers to effectively identify and participate in collective purchases.

### SUMMARY

The embodiments described herein seek to alleviate at least one of the problems described above in relation to the prior art.

Embodiments may include one or any combination of the different broad forms herein described.

In accordance with a first broad form, an embodiment includes a method of managing a purchase of a product from a vendor, the method being operable using a processing system, and including the steps of:

(i) receiving a plurality of purchase requests from a plurality of buyers, wherein each of the purchase requests includes information indicative of a product intended for purchase from the vendor by the respective buyers;

(ii) generating a collective purchase order based on the plurality of received purchase requests, the collective purchase order including information indicative of each product sought for purchase by the plurality of buyers, and, information indicative of a delivery location for the products to be purchased;

(iii) submitting the collective purchase order to the vendor to effect purchase of the products, wherein, by reference to a predetermined delivery cost criteria, a delivery cost is determined for delivering the purchased products together to the delivery location; and

(iv) allocating portions of the delivery cost amongst the plurality of buyers in accordance with a predetermined allocation criteria, wherein, the allocated portion of the delivery cost for each buyer is less than a delivery cost which is would otherwise be incurred by each buyer by reference to the predetermined delivery cost criteria, if the products purchased in the collective purchase order are delivered separately to each respective buyer.

The first broad form may be controlled by an administrator. The administrator may include a person, an automated processing system, and/or a combination thereof.

The delivery location may include a single delivery location.

Typically, the predetermined delivery cost criteria that may be used to determine the delivery cost for delivering purchased products together to the single delivery location may be based on a per shipment costing basis rather than on a per item costing basis. The cost-saving benefits for participating buyers may be particularly advantageous where the participating buyers may be involved in purchasing relatively cheap items. That is, the embodiments may work on the presumption that a large proportion of an overall cost incurred in acquiring a relatively cheap product online, may be attributable to the delivery cost. Thus, where a per shipment costing basis is adopted, the plurality of participating buyers may mutually assist each other by sharing the burden of a single delivery cost by virtue of effecting a group delivery.

It would be apparent to a person skilled in the art that any number of methodologies may be employed to determine the total shipping costs payable on a collective purchase order. For instance, shipping costs may be determined on a per shipment basis wherein a basic charge is payable for shipping the shipment of purchased products as well as an additional surcharge for each additional product shipped. Alternatively, shipping costs may be determined on a per shipment basis wherein a basic charge is payable for shipping the shipment of purchased products as well as an additional surcharge for each additional unit of weight (e.g. each kg) that exceeds a basic weight of the shipment. Yet in alternative methodologies, a basic shipping cost may be fixed at a relatively low cost in the event that a threshold number of products are purchased by the buyer. Yet in a further embodiment, the shipping cost can be based on a volumetric space occupied by the purchased product(s) of each buyer, and/or, the weight of the product(s) purchased.

Typically, the predetermined allocation criteria used to allocate portions of the delivery cost to participating buyers may include sharing the delivery cost amongst the buyers participating in the collective purchase order by reference to the relative proportion of each buyer's purchased goods to the total goods purchased by all participating buyers. It would be apparent to a person skilled in the art that in alternative embodiments, the delivery cost may be simply apportioned evenly amongst participating buyers irrespective of the actual number of products purchased by each buyer. In yet further embodiments, the delivery cost may be apportioned to the participating buyers using a non-uniform delivery cost allocation basis.

Typically, the vendor may include an online vendor. However, it would be appreciated by a person skilled in the art that the certain embodiments may be applicable where the vendor may not be accessible online. For instance, this may be the case where purchase orders may be placed with a vendor for products in a more traditional manner such as via telephone, facsimile or the like.

Typically, the processing system may include:

a central server; and

at least one relatively remote terminal communicably connected to the central server via a communication network.

The central server may also include a memory store adapted for storing a program executable on the central server for assisting in automating at least one of the method steps in accordance with the first broad form. For instance, and amongst other things, the central server may be programmed to automatically calculate the delivery cost for delivering purchased products together to a single delivery location, and/or, allocating portions of the delivery cost to the participating buyers.

Typically, the communication network may include the Internet, an intranet, a WAN, a LAN or any other suitable communication link. The remote terminals may include at least one of a PDA, a notebook computer, a mobile phone, and/or a desktop computer.

Typically embodiments include the step of providing a web site (hereinafter referred to as the “administrator web site”) adapted to assist in facilitating at least one of the method steps in accordance with the first broad form. For instance, the administrator web site may allow buyers to submit their purchase requests online for inclusion with any given collective purchase order. Typically, the administrator web site may be hosted on the central server and accessible by prospective buyers via the at least one remote terminal running a browser application adapted for viewing the administrator web site.

Each collective purchase order may be initiated and/or coordinated by an organizer. Typically, the organizer may include one of the buyers participating in the collective purchase order.

An embodiment may include a step preceding step (i) of the first broad form described above, wherein the organizer may first propose a collective purchase order by creating an advertisement inviting interested buyers to participate in the proposed collective purchase order. The advertisement may include details relating to at least one of the following:
(a) information indicating a time-frame in which interested buyers may be invited to submit a purchase request for inclusion with the proposed collective purchase order;
(b) information indicating a vendor to which the proposed collective purchase order is intended to be submitted;
(c) information indicating the scope of available products which may be purchased with the proposed collective purchase order from the vendor;
(d) information indicating the single delivery location associated with the proposed collective purchase order;
(e) information indicating a URL and/or IP address associated with a web site of the vendor;
(f) information indicating the organizer's identity;
(g) interactive information such as a hypertext link or an icon which may be activated when a buyer seeks to join the collective purchase order.

The advertisement may be created online by the organizer using advertisement creation software running on the administrator web site. For instance, the administrator web site may provide a standard template which may allow the organizer to selectively enter parameters defining the proposed collective purchase order which is to be the subject of the advertisement. Typically, when the organizer has entered the parameters into the template, the form may be submitted to the processing sever for processing. The advertisement details may for instance be also stored in the database.

Typically, embodiments may also include the step of displaying advertisement(s) created by the organizers on the administrator web site. Typically, the advertisements displayed on the administrator web site may be searchable by reference to at least one: of the following search parameters:
(a) by reference to the single delivery locations of products to be purchased under collective purchase orders. For instance, the location may be defined in terms of, continent, country, city, state/province, street name, and/or building name/number;
(b) by reference to the product types associated with the proposed collective purchase orders;
(c) by reference to the identities of vendors from which products in the proposed collective purchase orders are to be purchased.

Typically, embodiments may include the step of providing an index of such advertisements wherein the index may be sortable and/or searchable by reference to at least one of the above-mentioned search parameters. Advantageously, and in contrast to the prior art, interested buyers may be able to conveniently and expeditiously identify a proposed collective purchase order which may be compatible with the buyer's specific needs.

Typically, whilst advertisements may be displayed on the administrator web site after creation by an organizer, the collective purchase order associated with the advertisement may not be able to be joined by other interested buyers until the collective purchase has been “activated” by the organizer. Typically, in order to activate the newly created collective purchase order, the organizer may be required to submit a first purchase request which may or may not be later included in the actual collective purchase order submitted to the vendor. Typically, the step of activating the collective purchase order may also involve the organizer having to submit complete details of information relating to the proposed collective purchase order than has been initially entered into the advertisement creation template when the advertisement was first created. The detailed summary may include information relating to, amongst other things, costs component parameters associated with a purchase as part of the collective purchase order.

In certain embodiments, it may be envisaged that advertisements may be displayed to interested buyers via other communication formats such as e-mails, SMSs and so on.

The single delivery location associated with any given collective purchase order may be decided upon by the organizer of the collective purchase order. The single delivery location may typically include an address of a particular building or establishment such as the address of the organizer's physical premises. It would be appreciated that the single delivery location may vary depending upon the nature of the products purchased. For instance, if relatively large products are purchased with a collective purchase order, then it may be convenient for the single delivery location to be designated as a self-storage warehouse space or the like. Conversely, if the products that are purchased include relatively smaller items, then it may be suitable to have the products delivered to the organizer's premises for collection. Advantageously, the embodiments described herein may provide any person having access to a physical storage space at his/her disposal, with the convenience of generating an income stream from home simply by initiating, and/or coordinating collective purchase orders which make use of the storage space.

Embodiments may include the step of prospective buyers submitting their purchase requests to the central server via the remote terminal for processing. For instance, during the course of searching through advertisements displayed on the administrator web site, a prospective buyer may decide to participate in a suitable collective purchase order described in one of the advertisements by submitting a purchase request via the administrator web site. The purchase request may typically include at least one of the following details:
(a) information identifying the proposed collective purchase order which the buyer is seeking to participate in;
(b) information indicating a particular product(s) which the prospective buyer is seeking to purchase from the vendor;
(c) information indicating the number of product(s) to be purchased from the vendor;
(d) information indicating a monetary value of each product to be purchased from the vendor, and, a total monetary value of product(s) to be purchased from the vendor;
(e) personal details of the prospective buyer such as his/her name, address, and contact details;

Typically, the above details of the buyer's purchase request may be entered into an electronic template displayed on the administrator web site, which may thereafter be submitted to the central server for processing. Typically, upon submission of the buyer's details, this information may be stored into the memory store of the central server.

In certain embodiments, it may be envisaged that prospective buyers may be able to submit purchase requests for processing without necessarily specifying a particular collective purchase order which has being advertised. For instance, the prospective buyer may simply be required to submit details of the product sought to be purchased, and/or, together with information indicating a general location at which a product sought to be purchased should ideally be delivered, wherein, the processing system may be adapted to automatically identify which one of the advertised collective purchase orders, if any, may be compatible with the prospective buyer's needs, and thereafter, automatically allocating the buyer's purchase request to a compatible collective purchase order. Typically, embodiments may allow the buyer an option of selectively rejecting and/or accepting the automatically allocated collective purchase order, if so desired.

The purchase requests submitted by buyers to the central server may be stored in the central server memory store before generating a collective purchase order based on the plurality of buyer purchase requests. The central server may also be adapted to automatically submit the generated collective purchase order to the vendor when a threshold condition has been detected including for instance when:
(a) a predetermined threshold limit of buyers have been detected as having joined a collective purchase order; and/or
(b) a predetermined threshold time limit in which buyers are able to join a collective purchase order, is detected as having expired.

Embodiments may include the further step of selectively assigning each organizer a status level in accordance with a predefined hierarchy of status levels. Typically, the hierarchy of status levels may include three status levels—that is:

(i) a “junior” level;

(ii) a “senior” level; and

(iii) a “trusted” level.

Advantageously, the step of implementing a three-tiered hierarchy of organizers may assist the administrator in monitoring the reliability, trustworthiness and/or revenue-generating capacity of each participating organizer. Organizers which are perceived as being deficient in at least one or more of these performance categories may be periodically dispensed with by the administrator. Conversely, organizers which are able to demonstrate these performance attributes may be retained and/or promoted up the hierarchy accordingly.

The particular status level which may be assigned to a given organizer may depend upon a performance history of the organizer. Typically, each organizer may initially be assigned the “junior” status level and may progress through the “senior level” to the “trusted level” as the organizer successfully organizes more and more collective purchase orders. Typically, a benefit in rising to a higher level is that the organizer's opportunities for generating a revenue stream increases.

Typically, both junior and senior organizers may be restricted to generating revenue by charging buyers a fee for participating in collective purchase orders which they coordinate. However, whilst junior organizers may be required to actually participate in a collective purchase order themselves, senior organizers may not be required to do so. The administrator may typically receive a commission fee from a vendor based upon the amount of any customer traffic that is re-directed towards the vendor's web site from the administrator web site, and/or, based upon a percentage of actual revenue raised by the vendor as a result of collective purchase orders that are placed with the vendor. Typically, the commission fee payable to the administrator may be automatically monitored by embedding affiliate code in various icons/hypertext links on the administrator web site which may typically be activated by buyers/organizers whenever a vendor web site is opened for viewing; and/or whenever a buyer joins a collective purchaser order; and/or whenever a collective purchase order is actually submitted to a vendor to effect a group purchase. Thus for example, when an organizer intends to submit a collective purchase order for processing by a vendor to effect a group purchase of products for buyers, the organizer may click on a “Submit Collective Purchase Order” disposed on the administrator web site, wherein the icon may be embedded with an affiliate code which is automatically detected so as to keep track of the number of purchases made with the relevant vendor.

Organizers which are designated with a trusted status level may have the benefit of sharing a portion of the actual commission received by the administrator rather than having to charge buyers a participation fee. Typically, commission fees payable by the vendor to the administrator and/or to the trusted organizers from the administrator may be settled on a monthly basis typically utilizing an automated electronic payments system.

Embodiments may include the step of automatically formatting a user display running on the remote terminal, so as to present both the administrator web site, and, a vendor web site simultaneously. The automatic formatting of the remote terminal display may be triggered whenever a buyer responds to an advertisement. For instance, a buyer, in seeking to participate in a collective purchase order, may click on a “join collective purchase order” icon. The processing system may be programmed such that activation of the icon may result in the automatic splitting of the display screen into at least a first region in which the administrator web site is displayed, and, a second region in which the web site corresponding to the vendor URL and/or IP address is displayed.

Typically, the administrator web site may be positioned above the vendor web site on the same display screen. This may be particularly convenient in that a prospective buyer may be able to review collective purchase advertisements displayed on the administrator web site whilst simultaneously viewing details of products available for purchase from the vendor by looking at a catalogue of product information on the vendor web site.

In accordance with a second broad form, an embodiment includes a method of presenting information on a computer display used in managing a purchase of a product from a vendor, wherein the computer display is divided into at least a first region including a vendor web site, and, a second region including a purchaser web site via which an order is able to be placed to purchase a product from the vendor.

Embodiments may include the step of assigning at least one of a plurality of update authorization statuses to a buyer associated with the collective purchaser order wherein each of the update authorization statuses may be representative of an extent to which the collective purchaser order may be able to be modified by the buyer.

The extent to which the collective purchase order may be able to be modified may include an extent to which purchase requests received from buyers may be able to be excluded from the collective purchase order.

Typically, the update authorization statuses include at least one of:
a “remove” status which enables the buyer to cancel only its own purchase request from the collective purchase order; and/or
a “reject” status which enables the organizer to cancel any other buyer's purchase request from the collective purchase order.

Typically, the organizer of the collective purchase order may be assigned both the “remove” and “reject” update authorization statuses.

Typically, buyers associated with the collective purchase order that are not the organizer may be assigned the “remove” authorization update status only.

Typically, embodiments may include the step of providing an interface via which an exclusion of a purchase request may be effected by exercising a “remove” and/or “reject” authorization status.

Typically, the interface includes the web site.

Typically, in response to a purchase request being excluded from the collective purchase order, at least one of the following steps may be automatically performed:

(a) the delivery cost allocated to each of the plurality of buyers participating in the collective purchase order may be re-determined in view of the excluded purchase request by reference to the predetermined delivery cost allocation criteria; and/or

(b) non-delivery related costs associated with the collective purchase order may be re-determined in view of the excluded purchase request;

(c) a commission payable by the vendor in exchange for receiving the collective purchase order may be re-determined by reference to the excluded purchase request;

(d) the closing criteria may be re-determined in respect of the collective purchase order in view of the excluded purchase request;

Typically, the non-delivery related costs associated with the collective purchase order include at least one of:
(i) costs payable by buyers to the organizer for inclusion of their purchase requests in the collective purchase order;
(ii) arbitrary costs payable by buyers to the organizer which may be imposed by the organizer such as organizer delivery costs for delivering purchased products from for instance, an organizer's premises, to the buyer's premises, and/or, costs associated with the organizer unpacking purchased products upon delivery to the organizer's premises from the vendor;
(iii) a total cost payable to the vendor for products to be purchased in accordance with the collective purchase order is re-determined in view of the excluded purchase request.

In accordance with a third broad form, an embodiment includes a computerized system programmed to perform at least one of the method steps in accordance with the first and/or second broad forms.

In accordance with a fourth broad form, an embodiment includes a computer-readable medium storing a computer program for implementing at least one of the method steps in accordance with the first and/or second broad forms.

It would therefore be apparent to a person skilled in the art that the embodiments described herein may provide certain benefits over the prior art. Advantageously, the embodiments may assist in alleviating the delivery cost component per buyer participating in any given collective purchase order, and therefore, the total cost incurred per buyer in acquiring a product online. That is, the embodiments may conveniently exploit the delivery cost criteria used to calculate the delivery cost component by grouping purchased products together for delivery to a single location. In contrast, with prior art approaches the vendor has generally resorted to lowering the cost of a specific product itself in response to demand for that product. This may not be desirable for the vendor as it may adversely affect the profitability of the vendor.

A further perceived advantage is that each of the products requested for purchase from a given vendor by each of the plurality of buyers in a collective purchase order need not necessarily be the same type of product in order for the participating buyers to benefit from the collective purchase. This may be more convenient than prior art approaches in which a common product is generally required to be purchased in order for a group of buyers to generate sufficient purchasing power over the vendor so that the overall cost of purchasing the common product is lowered for each of the buyers. Therefore, the variety of products made available to buyers at a cheaper overall cost may be broader than with the prior art.

The embodiments described herein may also provide a convenient interface for buyers to identify a suitable collective purchase order to participate in which does not require the buyer to waste time trawling through an online forum. Moreover, the embodiments may allow a user to pro-actively initiate a collective purchase order without having to wait for a wholesaler to advertise one. Further advantages may also be provided in that the scope of the market for products which may be purchased by buyers may be greatly increased beyond the local consumer market—that is, products generated in overseas countries may be made more readily accessible to local buyers in a relatively cost effective manner due to the reduction in delivery costs component of acquiring the product(s).

Also advantageously, vendors may be readily encouraged to participate in the embodiments described herein in that they are generally not required to substantially alter their business practices for instance by heavily discounting the purchase price component of a product in order to attract customers. Instead, participating vendors may stand to gain financially through an increase in buyer traffic simply by allowing products purchased in the course of any collective purchase order to be shipped together to the designated single delivery location for pickup by the participating buyers. The vendor need not lower the product purchase price component of the products so as to reduce its profit margin. Moreover, the vendor may not even be aware that a collective purchase order is being implemented as the vendor may simply perceive that it selling a large number of products to a single buyer in a single purchase transaction. Thus, from the vendor's point of view, it may simply proceed to manage its business as per usual without experiencing any undue external interference.

The foregoing embodiments may be implemented as a computer program product comprised of instructions that are stored on one or more machine-readable media, and that are executable on one or more processing devices. The foregoing embodiments may be implemented as one or more apparatus or systems that include one or more processing devices and memory to store executable instructions to implement the processes and methods described herein.

The embodiments described herein may be more fully understood from the following detailed description in connection with the accompanying drawings.

### DESCRIPTION OF THE DRAWINGS

FIG. 1 shows a system diagram of a computerized system which is used in accordance with method steps of a first embodiment;

FIG. 2 shows a flowchart broadly depicting steps involved in performing the method in accordance with the first embodiment;

FIG. 3 shows a screen shot of the administrator web site as viewed on a browser of a buyer terminal in accordance with the first embodiment; and

FIG. 4 shows a screen shot from the point of view of a buyer terminal in which the administrator web site has been automatically formatted to be displayed on top of a vendor web site.

### DETAILED DESCRIPTION

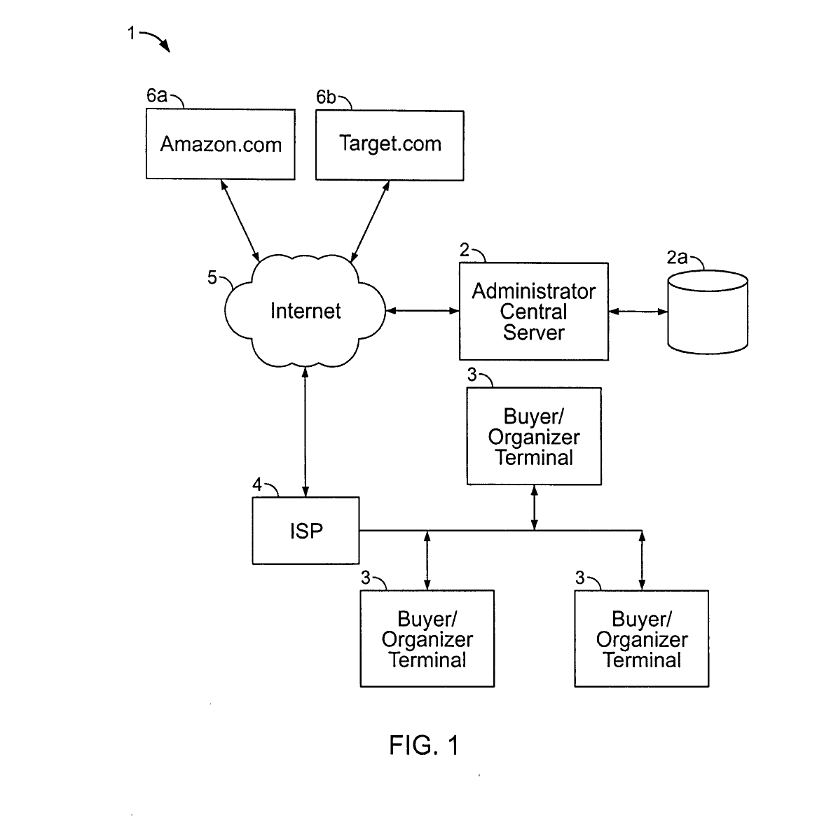

A first embodiment will be described herein with reference to FIGS. 1 to 4.

Referring firstly to FIG. 1, the first embodiment is implemented using a computerized system having a central server (2) which includes a standard desktop PC, and, a plurality of buyer terminals (3) which include desktop PCs, portable notebook PCs, or PDAs. The central server (2) is programmed to perform several functions one of which includes hosting a web site (i.e. the “administrator web site”) via which buyers are able to create, join, and/or coordinate collective purchase orders with various participating vendors. The buyer terminals (3) are able to run browser software via which buyers are able to interface with the administrator web site. It is conceivable that certain WAP-enabled mobile phones may also be suitable for use as buyer terminals (3) in this embodiment.

The buyer terminals (3) are communicably connected to the central server (2) via a communication network (5) which by way of example only, includes the Internet (5). The buyer terminals (3) are linked to a local ISP (4) which allows them to interact with the administrator central server (2) and the vendor servers (6a,6b) via the Internet.

In this embodiment, the system is controlled by an administrator (2) which in this case is the central server (2). The central server includes a database (2a) for storing system information to assist the central server (2) in carrying out its functions.

The first embodiment employs a hierarchical system of “organizers” (3) which are simply buyers (3), who amongst other things, are responsible for initiating, advertising, and completing collective purchase order transactions. The hierarchy involves assigning organizers (3) with one of three status levels—that is:

(a) a “junior” level;

(b) a “senior” level; and

(c) a “trusted” level.

Organizers (3) are all initially assigned the “junior” status level and are able to be promoted up the hierarchy through the “senior level” to the “trusted level” based upon the number of successful collective purchase orders that they organize. Organizers (3) are also provided with an incentive to rise up the hierarchy as this increases their opportunities to generate a revenue stream for themselves.

Both junior and senior organizers (3) are restricted to generating revenue by charging other buyers a fee for participating in collective purchase orders which they have initiated. However, whilst junior organizers are required to actually participate in collective purchase orders they have created, senior organizers (3) are not required to do so. The administrator (2) derives revenue on a commission fee basis from a plurality of participating vendors (6a,6b) based upon the amount of customer traffic that is re-directed towards the vendor's web site from the administrator web site, and, based upon a percentage of actual revenue raised by the vendors (6a,6b) as a result of collective purchase orders that are placed with the vendors (6a,6b).

The amount of a commission fee that is payable to the administrator (2) is automatically monitored by the use of affiliate codes embedded in various icons/hypertext links on the administrator web site and which when activated by buyers joining up with collective purchase order allow the automatic tracking of purchases from vendors. (6a,6b).

Organizers (3) which are designated with the trusted status level share in a portion of the actual commission fee received by the administrator (2) from vendors (6a,6b).

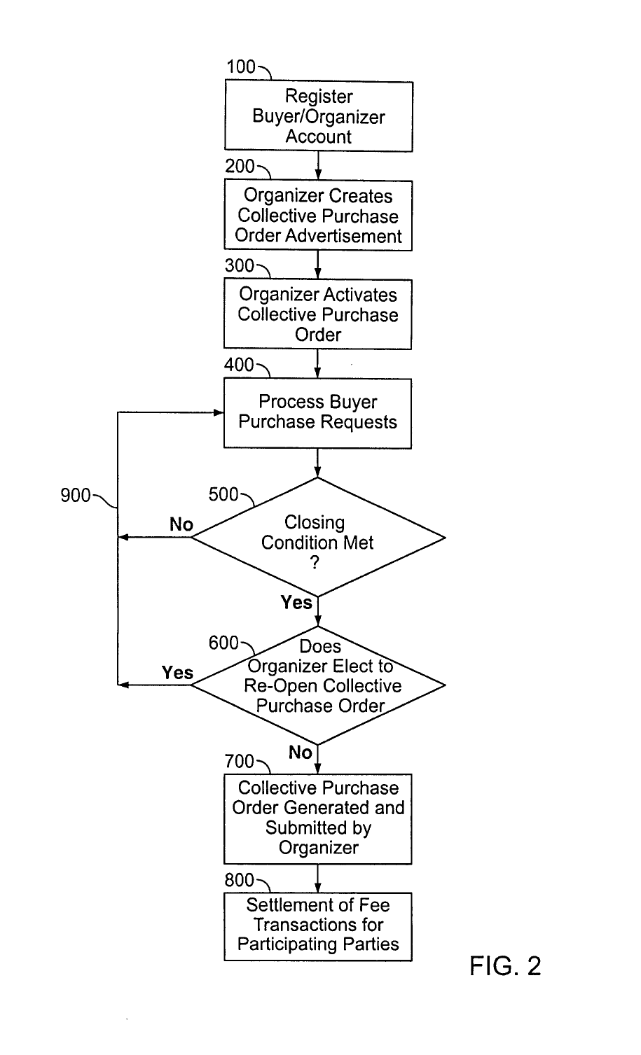

When a buyer (3) seeks to create a new collective purchase order, he must first register a new organizer account as indicated by block (100) in FIG. 2. The organizer account can be created online via the administrator web site by the buyer entering personal information such as his/her full name, email address, mailing address, phone number, and bank account details. The new organizer account details are stored into the database (2a) of the central server (2) for future reference. In this embodiment, once a buyer has initiated a new account, the buyer is able to utilize the account to manage its activities as both a participating buyer when seeking to join other collective purchase orders created by other organizers or, as an organizer in which the buyer itself initiates and manages new collective purchase orders.

After opening the organizer's new account, the organizer (3) is able to then create an advertisement for a proposed collective purchase order. This step is broadly represented at block (200) in FIG. 2, and involves the organizer (3) selectively entering advertisement parameters into a standard template via the administrator web site. The organizer (3) is required to submit at least the following details in setting up an advertisement:
a title of the collective purchase order;
the organizer's name, location, and contact details;
the product category;
the single delivery location of for the collective purchase order;
the vendor identity;
the IP address and/or URL of the vendor web site;
relevant currency information;
relevant exchange rate information;
a submission condition for submitting the collective purchase order. This includes either a time deadline, or, a limit on the number of buyers that can join the collective purchase order before it to be submitted;
cost information such as how the delivery cost is calculated for delivery of the purchased products;
information regarding a time at which purchased products should be collected by participating buyers from the single delivery location; and
the payment method by which the organizer is to be paid.

All advertisements are eventually displayed on the administrator web site and are searchable by reference to at least the following search parameters:

(a) the single delivery location;

(b) the product type; and

(c) the vendor's identity.

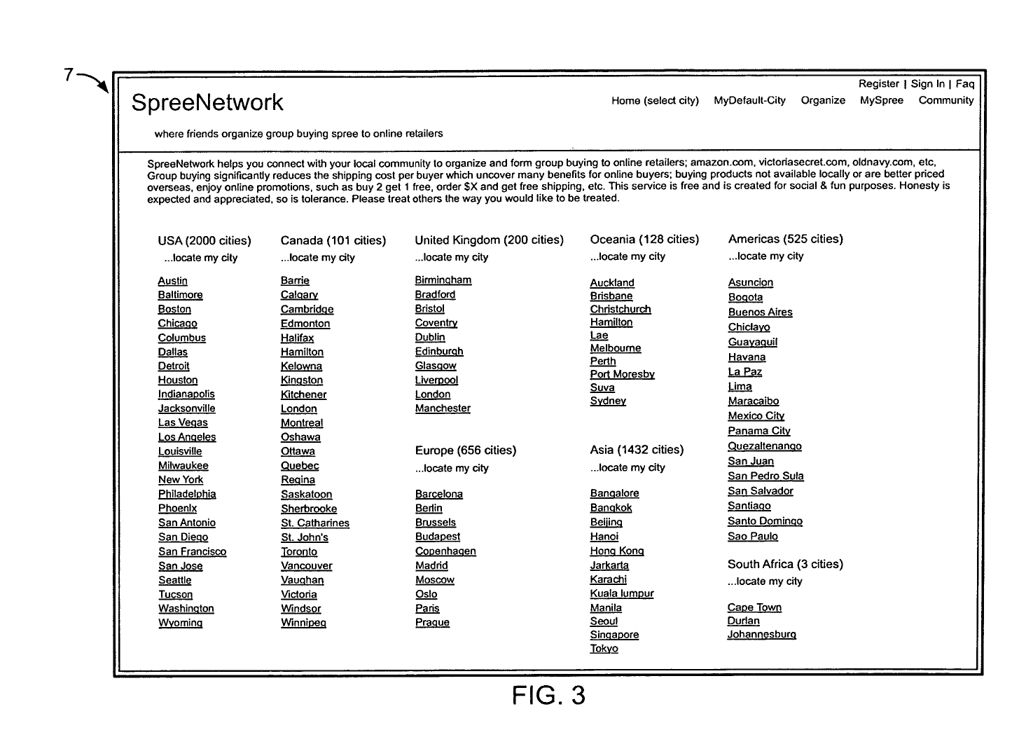

FIG. 3 shows an example screen shot of the administrator web site having hypertext links disposed thereon for a user to sort through active collective purchase orders. For instance, in FIG. 3, the web site includes a set of hypertext links representative of cities (7) in which various collective purchase orders are currently active, or, are pending activation. The buyers can progressively identify relevant collective purchase orders of interest to them after first clicking on a relevant city hypertext link (7) and a further hierarchy of hypertext links are provided relating to other search parameters such as product type, vendor type and so on.

Prior to activation of the collective purchase order, the advertisement is merely displayed on the administrator web site with only basic details of the collective purchase order being provided initially. Also, whilst the advertisement is displayed via the administrator web site, the actual collective purchase order to which it relates is not yet accessible by other buyers (3) until it has been “activated” by the relevant organizer (3).

In order for the organizer to activate the collective purchase order, he will firstly click on an “activate” icon displayed on the administrator web site. Clicking on the “activate” icon also results in automatic reformatting of the browser screen so that both the administrator web site and the vendor web site at which the collective purchase order is to be submitted, are viewable in side-by-side fashion. The administrator web site will generally automatically select a suitable template for use by other participating buyers when entering details of their purchase requests—that is, amongst other things, details of the product(s) which the buyer wants to purchase. Alternatively, the organizer is also able to manually select a suitable template from the library of purchase request templates.

The purchase request template that is selected for use by the participating buyer is either selected from a library of preexisting templates, or, is able to be created by the organizer. Pre-existing templates are listed in an index of templates accessible via the administrator web site. The index is searchable by reference to the relevant product type(s) associated with the collective purchase order.

Generally there will be a number of basic templates available for selection by the organizer each of which would be tailored to cover common product types. For instance a template could be provided in the library which relates to seafood, and certain fields which are displayed in the template could include “fish variety”, “size of fish”, “number of fish to be purchased”, and so on. Another template in the library could relate to computers and various fields provided in the template could relate to “computer brand”, “computer hardware installed”, “computer software installed” and so on.

In cases where a new or highly specialized type of product is to be the purchased from a vendor, it is useful for the organizer to create an entirely new and more suitable template. The administrator web site interface provides editing software by which an organizer is able to either amend an existing purchase request template to suit the needs of the collective purchase order, or alternatively, build a new purchase request template.

Upon completion of a new template, the organizer is prompted by the central server (2) as to whether the new template should be saved in to the library of templates. If the organizer (3) elects to do so, then the template is copied to the template library which is stored in the database (2a). Also, a new entry reflecting the newly created template is automatically listed in the searchable index so that other organizers may identify the new template and use it for other collective purchase orders where appropriate.

After selecting an existing template, or creating a new one, the organizer (3) is required to submit a first purchase request via a selected purchase request template before the collective purchase order is actually activated. The information contained in the organizer-completed purchase request template will be made available to other participating buyers so as to provide useful guidance regarding how to correctly fill out the purchase request template.

The organizer is also required to manually enter into appropriate fields displayed on the purchase request template, example cost component parameters associated with the first purchase request. These cost component parameters will assist in defining the total cost overall for the collective purchase order as well as providing the participating buyers with a guide as to the cost of purchasing their product(s) via the collective purchase order when submitting a purchase request.

In particular, the organizer is required to enter the following cost component parameters:
Cost component 1 (“C1”)—representative of the total product cost incurred by each buyer. This is the sum of the total cost of each line item purchases of each buyer. Total cost of each line item is determined by the quantity*dollar value of the product purchased in that line item.
Cost component 2 (“C2”)—Total cost due to charges to be split among all participating buyers. For example, Per Shipment cost which is split among the participating buyers.
Cost component 3 (“C3”)—Total cost due to charges per item. For example, if the organizer feels that it will be necessary to unpack certain purchased products, then he can include an additional charge for performing the service at for instance, at 50 cents per item.
Cost component 4 (“C4”)—Total cost per participating buyer. For example, if the organizer is providing a local delivery service himself, he can include local delivery charges at say 5 dollar per participating buyer.

Cost components “C1” is calculated by the system automatically. The sum of cost components “C2”, “C3” and “C4” for each buyer are the additional charges payable by each buyer to the organizer. Upon the organizer clicking a “Calculate button” the cost component parameters “C2”, “C3” and “C4” in the organizer's order will be duplicated to the rest of the participating buyers purchase requests. The system will then generate the total order cost for the organizer and the buyers. And this is in fact the cost payable by the buyer to the organizer.

The organizer (3) is required to manually enter the above cost component information into a suitably formatted costs component template which, in this embodiment, is implemented as part of the purchase request template.

A number of suitable costs templates are provided for use by the organizer (3) which are stored as a library of pre-existing costs templates in the central server database (2a). A listing of each available template is displayed via the administrator web site, and is searchable by reference to either product type and/or vendor type. As with the purchase request templates, cost component templates are able to be either edited from existing templates, or, created using editing software accessible via the administrator web site. New cost component templates are automatically stored into the library and the index is automatically updated with a new entry reflecting the inclusion of a new cost component template.

After all the cost component information has been entered into the costs component template, the organizer can activate automatic processing of the costs component information stored therein by clicking on a “Process Costs” icon displayed on the template. Thereafter, the central server (2) is programmed to automatically retrieve the cost component information for the collective purchase order and to calculate the total cost for the collective purchase order which is payable to the vendor (6a,6b), and, an overall cost payable per buyer based on the costs component information entered into the costs component template in accordance with the organizer defined cost component parameters “C1”, “C2”, “C3” and “C4”.

The step of activating the newly created collective purchaser order so that the buyer can commence participating in the collective purchase order, is broadly represented at block (300) in FIG. 2.

It should be noted that if the organizer is a junior organizer, then the first purchase request that he submits will actually be included in the collective purchase order. However, this is not necessarily the case with senior and/or trusted organizers, who may elect to simply submit example purchase requests which aren't subsequently included in the collective purchase order.

Each active advertisement that is displayed on the administrator web site will include status information indicating whether the collective purchase order is still open or whether it has now been closed. If alive, the status information will also indicate how much time is left before the advertisement is scheduled to be closed and/or how many more purchase requests will be accepted from interested buyers as part of the collective purchase order before the advertisement is closed. The administrator web site will also display statistical information relating to, amongst other things, the volume and nature of collective purchase orders that have been initiated and/or participated in by buyers classified by reference to location, product type and/or vendor type.

In order for a prospective buyer to join an active collective purchase order of interest to him/her after reviewing the displayed advertisement(s) on the administrator web site, the buyer will click on a “submit purchase request” icon or hypertext link disposed adjacent to the advertisement on the terminal browser. Whenever the icon or hypertext link is clicked on by the buyer, affiliate code embedded in the icon or link is programmed to automatically causes the following actions to occur:
(a) a counter is updated which keeps track of the number of purchases that are directed toward the vendor; and
(b) the browser screen on the buyer terminal splits in two to show the administrator web site and vendor web site side-by-side.

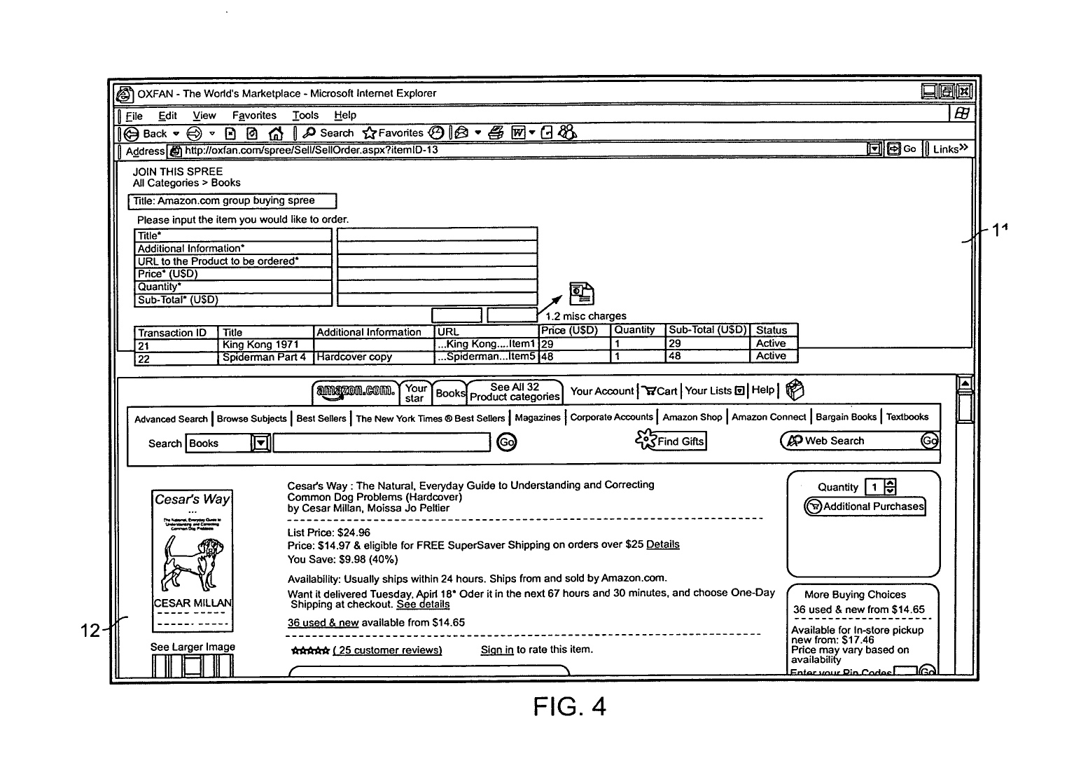

An example of the split-screen format is shown in the screen-shot in FIG. 4 in which the buyer terminal browser has been automatically formatted to display the administrator web site (11) neatly positioned on top of a vendor web site (12). Also, the administrator web site is automatically adjusted so as to display a template which is specifically designed to prompt the buyer to enter, amongst other things, the details of the product and product quantity which he is seeking to purchase from the vendor as part of the collective purchase order. The buyer will then be required to enter the following details in to the template:
(a) the name and contact details of the buyer seeking to participate in the collective purchase order;
(b) the name or identifier of the product(s) sought for purchase from the vendor;
(c) the quantity of the product(s) sought for purchase from the vendor; and
(d) the buyer's bank account details via which funds will be used to later pay for the acquisition of product(s) from the vendor.

The step of processing buyer purchase requests is broadly represented at block (400) in FIG. 2.

If the buyer is a first time participant in a collective purchase order, then a new buyer account is created in the database (2a) of the central server (2) using the submitted buyer details. This information is able to be later retrieved and used by the central server (2) in for instance effecting payment transactions relating to the collective purchase order. Once the buyer account, this enables the buyer to commence participating as a mere buyer in any collective purchase orders, or, to act as an organizer in initiating new collective purchaser orders.

In this embodiment, the central server (2) is adapted to monitor a threshold condition indicative of when the collective purchase order should be closed, and, to automatically notify the relevant organizer when the closing condition has been met. For instance, the central server (2) is adapted to conveniently send an SMS message or e-mail message to the relevant organizer automatically via the communication network when the threshold closing conditions has been detected.

Thereafter, once the threshold condition is detected as being met in respect of the collective purchase order—for instance, where a deadline has arrived by which to close the collective purchase order, further purchase requests from buyers will not be accepted for inclusion in the collective purchase order temporarily. The advertisement for that particular collective purchase order is also removed temporarily from the display on the administrator web site, or, is at least amended to indicate that its status is now “inactive”, when the threshold closing condition has been detected. This step is broadly represented at block (500) in FIG. 2.

The detection of the threshold condition does not necessarily result in the collective purchase order being closed permanently, but instead, the organizer is provided with the opportunity to re-open the collective purchase order despite the original threshold condition being met. This step is broadly represented at block 600 in FIG. 2. This may be the case for instance where a particular product requested for purchase by a participating buyer is out of stock, and, submission of the collective purchase order to the vendor in these circumstances would not result in the lower cost benefits being passed on to the participating buyers—that is, because the omission of the out of stock product from the collective purchase would not result in a particular promotional discount being obtained from the vendor in return for submitting the collective purchase order. In the event that the organizer elects for the collective purchase order to proceed without re-opening, this step is broadly represented by block (900) in FIG. 2.

The organizer (3) will be notified automatically by the central server when the original threshold condition is met as to whether all other conditions are satisfied for the collective purchase order for it to achieve its intended cost benefits if submitted to the vendor (61,6b) to effect the purchase. In this embodiment, the vendor (6a,6b) is able to communicate with the central server (2), for instance, in order to notify the central server (2) that a particular product intended for purchase is out of stock. Therefore it would be apparent to a person skilled in the art that some mechanism would likely be implemented by which the vendor (6a,6b) is able to preview the collective purchase orders before they are submitted so that a proper notification of a deficiency in the collective purchase order can be sent to the organizer at an appropriate time.

Alternatively, the organizer can be required to personally inquire as to whether any deficiencies are associated with the collective purchase and by submitting a draft collective purchase order to the relevant vendor, allowing the vendor to examine the list of requested products for purchase, and then, if the vendor (6a,6b) reports any deficiencies in the purchase order, the organizer (3) is able to re-open the collective purchase order if so desired.

The step of re-opening the collective purchase order involves the organizer communicating a suitable message to the central server (2), for instance, via an e-mail, SMS, Voice telephone message, via the administrator web site interface or any other suitable communication means. In response, the central server (2) will cancel the “inactive” status of the collective purchase order and again display the relevant advertisement on the web site once more. The closing condition for the re-opened collective purchase order can be set by the organizer (3) via the message to the central server (2). For instance, the organizer (3) could instruct the central server (2) to detect when a further X number of products, and/or $X worth or products have been further requested for purchase before again closing the collective purchase order.

In the event that the original threshold condition is not met, then the collective purchase order remains active and the corresponding advertisement displayed on the administrator web site continues to invite buyers to participate in the collective purchase order. Further buyer purchase requests are thus able to be processed by the central server (2) for inclusion in the collective purchase order as represented by the loop (900) in FIG. 2.

Before actually submitting the collective purchase order to the vendor and thereby being liable for payment, the organizer can request that certain participating buyers be required to provide payment to the organizer (3) upfront in order to minimize the organizer's exposure to risk. This is required for instance from participating buyers who have not previously placed a purchased request before and whose reliability has therefore not yet been verified.

Once a group buy is closed, further steps are required by the organizer before the collective purchase order can actually be submitted to the vendor for processing. In this embodiment, it is necessary that any upfront payments which are expected from first time participating buyers have been received. The organizer will click on an icon that is displayed on the administrator web site which causes a new template to be presented to the organizer for completion. The template prompts the organizer to verify a payment status of each participating buyer in the collective purchaser order. Thereafter, the organizer is prompted by the template to confirm whether payments have been received upfront by first time participating buyers, and if so, the template allows the organizer to confirm such payments. The template also allows the organizer to check a “pay later” box corresponding to purchase requests placed by participating buyers who do not need to pay upfront.

Once this payment checking procedure has been completed, an icon becomes active on the administrator web site with the word “Submit Order” together with the name of the vendor to which the order is intended to be submitted. For instance, the icon may be title “Submit Order to Amazon.com” and so on.

Upon clicking the icon, a displayed on the buyer terminal via which the buyer/organizer is interacting with the central server is automatically adjusted so as to present both the administrator web site, and, a vendor web site simultaneously. The administrator web site is positioned above the vendor web site on the same display screen.

Moreover, the administrator web site displays details of the product(s) to be purchased for each participating buyer whilst the vendor web site initially shows the home page of the retailer. As the organizer clicks on each product's URL on the administrator web site display, a corresponding product web page is retrieved for display on the vendor web site display (i.e the bottom screen). The organizer is simply referencing the information in the administrator web site screen for each buyer's product details in order to submit the order for each buyer in turn via the vendor screen below accordingly.

At the same time that the collective purchase order is actually submitted to the vendor, the organizer also transmits the appropriate funds to the vendor, as calculated by the central server (2), to cover the purchase price of the requested products and other incidental costs. At first instance, the organizer will generally submit some of its own funds in advance to cover these costs together with any upfront payments received from first-time participating buyers.

In this embodiment, commission fees payable by the vendor (6a,6b) to the administrator and/or to the trusted organizers from the administrator may be settled on a monthly basis typically utilizing an automated electronic payments system. This step is broadly represented by block (800) in FIG. 2.

Thereafter, the purchased goods are delivered to the single delivery location specified by the organizer (3) in the collective purchase order, and are ready for collection by the participating buyers accordingly.

Buyers who have not yet participated either as a buyer or as an organizer in any collective purchase orders may nevertheless still elect to register a buyer account for storage in the database (2a) of the central server (2). This is accomplished by the user completing and submitting a stand-alone registration form available online via the administrator web site. This enables the registered buyer to access a personalized web page under password-access control which for instance, provides a summary of the buyer's purchasing history, a listing of any pending purchase requests that have been submitted, as well as information regarding amounts which are payable to organizers and so on by the buyer.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavor to which this specification relates.

Those skilled in the art will appreciate that the embodiments described herein are susceptible to variations and modifications other than those specifically described. All such variations and modification which become apparent to persons skilled in the art, should be considered to fall within the spirit and scope of the claims. It is to be understood that the embodiments includes all such variations and modifications. The embodiments also includes all of the steps and features, referred or indicated in the specification, individually or collectively, and any and all combinations of any two or more of the steps or features.

Components of different embodiments described herein may be combined to form other embodiments not specifically set forth above. Other embodiments not specifically described herein are also within the scope of the following claims.

What is claimed is:

1. A method of managing a purchase of a product from a vendor, the method being operable using a processing system, and comprising:
(i) receiving a plurality of purchase requests from a plurality of buyers, wherein each of the purchase requests includes information indicative of a product intended for purchase from the vendor by respective buyers;
(ii) generating a collective purchase order based on the plurality of received purchase requests, the collective purchase order including information indicative of each product sought for purchase by the plurality of buyers, and information indicative of a delivery location for the products to be purchased;
(iii) submitting the collective purchase order to the vendor to effect purchase of the products, wherein, by reference to a predetermined delivery cost criteria, a delivery cost is determined for delivering the products together to the delivery location; and
(iv) allocating portions of the delivery cost amongst the plurality of buyers in accordance with a predetermined allocation criteria, wherein, the allocated portion of the delivery cost for each buyer is less than a delivery cost which would otherwise be incurred by each buyer by reference to the predetermined delivery cost criteria if the products purchased in the collective purchase order are delivered separately to each of the plurality of buyers.

2. The method of claim 1, further comprising delivering the purchased products to a single delivery location.

3. The method of claim 1, wherein the predetermined delivery cost criteria is based on a per shipment basis and not a per item basis.

4. The method of claim 1, wherein the allocation criteria includes distributing the delivery cost evenly amongst the plurality of buyers.

5. The method of claim 1, further comprising using a web site via which the plurality of purchase requests are able to be received from the plurality of buyers.

6. The method of claim 5, further comprising having one of the plurality of buyers advertising a proposed collective purchase order on the web site.

7. The method of claim 6, further comprising providing an index of advertisements on the web site.

8. The method of claim 7, wherein the index is searchable by reference to at least one of the following search parameters:
(a) a delivery location associated with the proposed collective purchase order;
(b) a product type intended for purchase with the proposed collective purchase order; and/or
(c) a vendor identity from which products are intended to be purchased.

9. The method of claim 1, wherein the delivery location includes at least one of a building, or, a geographical landmark which is recognizable to at least some of the plurality of buyers.

10. The method of claim 1, further comprising collecting a fee from each of the plurality of buyers in exchange for having their purchase requests included in the collective purchase order.

11. The method of claim 1, further comprising collecting a fee from the vendor in exchange for submitting the collective purchase order with the vendor to effect purchase of the products.

12. The method of claim 11, wherein the fee collected from the vendor includes a commission fee based on at least one of:
(a) a number of collective purchase orders which are referred to the vendor to effect purchase of the products;
(b) a purchase value of the collective purchase order submitted to the vendor; and/or
(c) a number of products purchased from the vendor in the collective purchase order.

13. The method of claim 12, further comprising associating an affiliate code indicative of the vendor with at least one of a hypertext link and/or icon disposed on a web site which is activated when submitting a collective purchase order to the vendor, wherein the number of collective purchase orders which are referred to the vendor is able to be determined by detecting the affiliate code associated with the hypertext link and/or icon each time the hypertext link and/or icon is activated.

14. The method of claim 1, further comprising using an organizer for performing at least one of receiving, generating, submitting, and allocating.

15. The method of claim 14, wherein the organizer includes a buyer that has initiated the collective purchase order.

16. The method of claim 14, further comprising associating at least one of a plurality of status levels with the organizer.

17. The method of claim 16 wherein the plurality of status levels which are associated with the organizer includes at least one of the following:
(a) a junior status level;
(b) a senior status level; and
(c) a trusted status level;
wherein each of the plurality of the status levels is representative of predefined parameters within which the organizer is able to operate.

18. The method of claim 17 wherein:
(a) the junior status level indicates that the organizer is able to receive a fee from a buyer in exchange for submitting a collective purchase order which includes the buyer's purchase request, and, each collective purchase order that is submitted by the organizer is required to include a purchase request originating from the organizer;
(b) the senior status level indicates that the organizer is able to receive a fee from a buyer in exchange for submitting a collective purchase order which includes the buyer's purchase request, and, each collective purchase order that is submitted by the organizer is not required to include a purchase request originating from the organizer;
(c) the trusted status level indicates that the organizer is able to receive a commission based fee derived from a vendor to which the organizer submits the collective purchase order.

19. The method of claim 16, further comprising associating one of the plurality of status levels with the organizer based on a predefined performance criteria, the performance criteria including at least one of the following factors:
(a) a number of collective purchase orders submitted by the organizer;
(b) a value of products purchased in the course of submitting collective purchase orders;
(c) a number of products purchased in the course of submitting collective purchase orders.

20. The method of claim 1, further comprising, prior to receiving the plurality of purchase requests, an organizer activating a collective purchase order, wherein activating comprises:
(I) the organizer entering parameters which define the collective purchase order via a web site;
(II) the organizer initializing the collective purchaser via the web site, by submitting a purchase request wherein the purchase request may include a real purchase request which is to be included in the collective purchase order, or, a token purchase request which is adapted to trigger activation of the collective purchase order but which is not included in the collective purchase order;
wherein, upon activation of the collective purchase order, buyers are able to participate in the collective purchase order.

21. The method of claim 1, further comprising providing a plurality of purchase request templates via which the plurality of buyers are able to enter details of their respective purchase requests, wherein each of the purchase request templates includes indicia which is adapted to prompt the buyer to enter purchase request details uniquely associated with the product type to be purchased.

22. The method of claim 1, further comprising providing a computer display via which at least one of the plurality of buyers is able to submit its purchase request, wherein the computer display is divided into at least a first region including a vendor web site, and, a second region including a purchaser web site via which a purchase request is able to be placed by the buyer to participate in a collective purchase order with the vendor.

23. The method of claim 22, wherein the computer display is automatically divided into the first and second regions in response to activation of at least one of a hypertext link and/or an icon disposed on the purchaser web site.

24. The method of claim 23, wherein the order includes a collective purchase order adapted for purchasing a plurality of products from the vendor.

25. The method of claim 1, further comprising automatically monitoring when a closing criteria is met, wherein, if closing criteria is met, then no further buyer purchase requests are accepted for inclusion in the collective purchase order.

26. The method of claim 25 wherein the closing criteria includes at least one of:
(a) a threshold number of purchase request being receive from buyers in respect of the collective purchase order; and/or
(b) a threshold value of products purchased is detected in respect of the collective purchase order, and/or
(c) a threshold time limit has expired in respect of the collective purchase order.

27. The method of claim 1, further comprising assigning at least one of a plurality of update authorization statuses to a buyer associated with a collective purchaser order wherein each of the update authorization statuses are representative of an extent to which the collective purchaser order is able to be modified by the buyer.

28. The method of claim 27, wherein the extent to which the collective purchase order is able to be modified includes an extent to which purchase requests received from buyers are able to be excluded from the collective purchase order.

29. The method of claim 28, wherein the update authorization status includes at least one of:
a “remove” status which enables the buyer to cancel only its own purchase request from the collective purchase order; and/or
a “reject” status which enables the organizer to cancel any other buyer's purchase request from the collective purchase order.

30. The method of claim 29, wherein the organizer of the collective purchase order is assigned both the “remove” and “reject” update authorization statuses.

31. The method of claim 29, wherein buyers associated with the collective purchase order that are not the organizer are assigned the “remove” authorization update status only.

32. The method of claim 29, further comprising providing an interface via which an exclusion of a purchase request can be effected by exercising a “remove” and/or “reject” authorization status.

33. The method of claim 32, wherein the interface includes the web site.

34. The method of claim 27, wherein, in response to a purchase request being excluded from the collective purchase order, at least one of the following is automatically performed:
(a) the delivery cost allocated to each of the plurality of buyers participating in the collective purchase order is re-determined in view of the excluded purchase request by reference to the predetermined delivery cost allocation criteria; and/or
(b) non-delivery related costs associated with the collective purchase order are re-determined in view of the excluded purchase request;
(c) a commission payable by the vendor in exchange for receiving the collective purchase order is re-determined by reference to the excluded purchase request;
(d) the closing criteria is re-determined in respect of the collective purchase order in view of the excluded purchase request.

35. The method of claim 34, wherein non-delivery related costs associated with the collective purchase order comprises at least one of:
(a) costs payable by buyers to the organizer for inclusion of their purchase requests in the collective purchase order;
(b) a total cost payable to the vendor for products to be purchased in accordance with the collective purchase order is redetermined in view of the excluded purchase request.

36. The method of claim 14, further comprising the organizer predefining a plurality of cost component parameters wherein the cost component parameters define how at least one cost component payable by each buyer participating in the collective purchase is to be determined by reference to product(s) purchased.

37. The method of claim 36, further comprising the organizer programming a costs component template to automatically calculate costs components payable by a buyer participating in the collective purchase order in response to the buyer entering details of its intended purchase into the costs component template.

38. The method of claim 1, further comprising verifying a payment status of each buyer participating in the collective purchase order prior to enabling submission of the collective purchase order.

39. The method of claim 38, wherein verifying the payment status comprises at least one of:
(a) verifying that any upfront payments required of the buyer(s) have been received; and/or
(b) verifying that payment from the buyer(s) will be collected later.

40. A method of presenting information on a computer display used in managing a purchase of a product from a vendor, wherein the computer display is divided into at least a first region including a vendor web site, and, a second region including a purchaser web site via which an order is able to be placed to purchase a product from the vendor.

41. A computer system comprising:
one or more processing devices; and
memory to store instructions that are executable by the one or more processing devices to manage a purchase of a product from a vendor;
wherein the instructions are executable by the one or more processing devices to:
(i) receive a plurality of purchase requests from a plurality of buyers, wherein each of the purchase requests includes information indicative of a product intended for purchase from the vendor by respective buyers;
(ii) generate a collective purchase order based on the plurality of received purchase requests, the collective purchase order including information indicative of each product sought for purchase by the plurality of buyers, and information indicative of a delivery location for the products to be purchased;
(iii) submit the collective purchase order to the vendor to effect purchase of the products, wherein, by reference to a predetermined delivery cost criteria, a delivery cost is determined for delivering the products together to the delivery location; and
(iv) allocate portions of the delivery cost amongst the plurality of buyers in accordance with a predetermined allocation criteria, wherein, the allocated portion of the delivery cost for each buyer is less than a delivery cost which would otherwise be incurred by each buyer by reference to the predetermined delivery cost criteria if the products purchased in the collective purchase order are delivered separately to each of the plurality of buyers.

42. One or more machine-readable media for storing instructions that are executable by one or more processing devices to manage a purchase of a product from a vendor, the instructions being executable to:
(i) receive a plurality of purchase requests from a plurality of buyers, wherein each of the purchase requests includes information indicative of a product intended for purchase from the vendor by respective buyers;
(ii) generate a collective purchase order based on the plurality of received purchase requests, the collective purchase order including information indicative of each product sought for purchase by the plurality of buyers, and information indicative of a delivery location for the products to be purchased;
(iii) submit the collective purchase order to the vendor to effect purchase of the products, wherein, by reference to a predetermined delivery cost criteria, a delivery cost is determined for delivering the products together to the delivery location; and
(iv) allocate portions of the delivery cost amongst the plurality of buyers in accordance with a predetermined allocation criteria, wherein, the allocated portion of the delivery cost for each buyer is less than a delivery cost which would otherwise be incurred by each buyer by reference to the predetermined delivery cost criteria if the products purchased in the collective purchase order are delivered separately to each of the plurality of buyers.
